(19) United States
(12) Patent Application Publication
(10) Pub. No.: US 2005/0039631 A1
(43) Pub. Date: Feb. 24, 2005

(54) Pigmented inkjet ink set

(76) Inventors: Kevin J. Best, Hockessin, DE (US); Robert Paul Held, Newark, DE (US); Ronald Roman, Hockessin, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/844,869

(22) Filed: May 13, 2004

Related U.S. Application Data
(60) Provisional application No. 60/472,969, filed on May 23, 2003.

(51) Int. Cl. C09D 11/02; B41J 2/01

(52) U.S. Cl. 106/31.6; 106/31.9; 347/100

(57) ABSTRACT

This invention pertains to an ink set for inkjet printing, in particular to an ink set comprising of at least three colored inks based on specified pigment colorants.

### CROSS-REFERENCE TO RELATED APPLICATION

This application claims priority under 35 U.S.C. §119 from U.S. Provisional Application Ser. No. 60/472,969 (filed May 23, 2003), which is incorporated by reference herein for all purposes as if fully set forth.

### BACKGROUND OF THE INVENTION

This invention pertains to an ink set for inkjet printing, in particular to an ink set comprised of at least three colored inks based on specified pigment colorants.

Inkjet printing is a non-impact printing process in which droplets of ink are deposited on print media, such as paper, to form the desired image. The droplets are ejected from a printhead in response to electrical signals generated by a microprocessor. Inks used in such recording are subject to rigorous demands including, for example, good dispersion stability, ejection stability, and good fixation to media.

Both dyes and pigments have been used as colorants for inkjet inks. While dyes typically offer superior color properties compared to pigments, they tend to fade quickly and are more prone to rub off. Inks comprising pigments dispersed in aqueous media are advantageously superior to inks using water-soluble dyes in water-fastness and light-fastness of printed images.

Inks set with various combinations of pigments have been disclosed. In U.S. Pat. No. 5,994,427 there is disclosed a pigment ink set with PB 15:3 cyan ink, PR 122 magenta ink and PY 74 yellow ink. U.S. Pat. No. 5,738,716 discloses a similar ink set except the cyan ink contains bisphthalocyanylalumino tetraphenylsiloxane pigment.

In U.S. Pat. No. 6,395,079 there is disclosed a pigment ink set comprising PB 15:3 cyan ink, PR 122 magenta ink, PY 74 yellow ink and PB 7 (carbon black) black ink. U.S. Pat. No. 6,153,000 discloses a pigment ink set comprising PB 15:3 cyan ink, PR 122 magenta ink and PY 155 yellow ink.

In U.S. Pat. No. 6,030,441 there are several pigment ink sets disclosed, including several sets with PB 15:3 cyan ink, PR 122 magenta ink, and various different yellow inks. In one case the yellow ink contains PY 110 and 109 pigment, in another case the yellow ink contains PY 138, and in yet another case the yellow ink contains PY 180 pigment.

Other pigment combinations, and ink sets with additional colors, are disclosed in U.S. Pat. No. 6,152,999, U.S. Pat. No. 6,419,733 and U.S.20020043175.

All of the above-referenced publications are incorporated by reference herein for all purposes as if fully set forth.

Still there is need for pigment ink sets that extend and exploit the advantages of pigments as colorants for inkjet inks.

### SUMMARY OF THE INVENTION

In accordance with one aspect of the present invention, there is provided an ink jet ink set for color printing comprising at least three differently colored inks, wherein:

(i) at least one of the inks is a cyan ink comprising a vehicle and copper phthalocyanine pigment selected from the group consisting of PB 15:3 and PB 15:4;

(ii) at least one magenta ink comprising a vehicle and PR 122 magenta pigment; and

(iii) at least one yellow ink comprising a vehicle and PY 95 yellow pigment.

Preferably the ink set comprises at least four differently colored inks, wherein at least one of the inks is a black ink, preferably comprising a vehicle and a carbon black pigment. The ink set may optionally include one or more other colored inks such as, for example, an orange ink and/or a green ink.

The present invention also provides a method for ink jet printing onto a substrate, comprising the steps of:

A) providing an ink jet printer that is responsive to digital data signals;

B) loading the printer with a substrate to be printed;

C) loading the printer with the above-mentioned ink jet ink set

D) printing onto the substrate using the inkjet ink set in response to the digital data signals.

The use of a yellow ink based on Y95 provides excellent chroma and favorable hue angle (compared to other prior art yellow pigment ink jet inks) so that, in combination with the cyan and magenta inks as described above, a large color gamut is achieved. Also, advantageously, because the Y95 is a ‘neutral’ shade of yellow, the ink set is able to attain a good balance of greens and reds. Furthermore, there is demonstrated hereinafter that Y95 can be suitably dispersed and formulated into an ink which meets the rigorous demands of ink jet printing.

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination. In addition, references in the singular may also include the plural (for example, “a” and “an” may refer to one, or one or more) unless the context specifically states otherwise.

### DETAILED DESCRIPTION OF THE PREFERRED EMBODIMENTS

In accord with the instant invention there is provided an ink set. The ink set comprises at least three primary inks: at least one cyan ink, at least one magenta ink and at least one yellow ink. Each of these primary inks is in turn comprised of a vehicle and an appropriate colorant (which is a pigment) dispersed in the vehicle.

The at least one cyan ink is preferably comprised of a copper phthalocyanine pigment, most preferably C.I. pigment blue 15:3 and/or 15:4. The at least one magenta ink is preferably comprised of a quinacridone pigment, most preferably C.I. pigment red 122. The at least one yellow ink is comprised of C.I. pigment yellow 95.

Pigments are routinely referred to by their “CI” number. Information about pigments with “CI” numbers can be found from the “Colour Index” published by Society of Dyers and Colourists (SDC) in conjunction with the American Association of Textile Chemists and Colorists (AATCC). The SDC web site is http://www.sdc.org.uk/publications/ci4intro.htm, and further information may be found by reference thereto.

The ink set may optionally include a black ink, preferably comprising carbon black pigment. When present, the carbon black pigment is preferably a “self-dispersing” carbon black such as those disclosed, for example, in U.S. Pat. No. 5,554,739, U.S. Pat. No. 5,571,311, U.S. Pat. No. 5,609,671, U.S. Pat. No. 5,672,198, U.S. Pat. No. 5,698,016, U.S. Pat. No. 5,707,432, U.S. Pat. No. 5,718,746, U.S. Pat. No. 5,747,562, U.S. Pat. No. 5,749,950, U.S. Pat. No. 5,803,959, U.S. Pat. No. 5,837,045, U.S. Pat. No. 5,846,307, U.S. Pat. No. 5,851,280, U.S. Pat. No. 5,861,447, U.S. Pat. No. 5,885,335, U.S. Pat. No. 5,895,522, U.S. Pat. No. 5,922,118, U.S. Pat. No. 5,928,419, U.S. Pat. No. 5,976,233, U.S. Pat. No. 6,057,384, U.S. Pat. No. 6,099,632, U.S. Pat. No. 6,123,759, U.S. Pat. No. 6,153,001, U.S. Pat. No. 6,221,141, U.S. Pat. No. 6,221,142, U.S. Pat. No. 6,221,143, U.S. Pat. No. 6,277,183, U.S. Pat. No. 6,281,267, U.S. Pat. No. 6,329,446, U.S. Pat. No. 6,332,919, U.S. Pat. No. 6,375,317, U.S.2001/0035110, EP-A-1086997, EP-A-1114851, EP-A-1158030, EP-A-1167471, EP-A-1122286, WO01/10963, WO01/25340 and WO01/94476 (the disclosures of which are incorporated by reference herein for all purposes as if fully set forth).

The ink set may optionally include other colors such as an orange ink, especially an orange ink comprised of one or more of C.I. pigment orange 43, 36, 34, 61, 64 or 71; and/or a green ink, especially a green ink comprised of one or more of C.I. pigment green 36 or 7.

Traditionally, pigments are stabilized to dispersion in a vehicle by dispersing agents, such as polymeric dispersants or surfactants. More recently, though, so-called “self-dispersible” or “self-dispersing” pigments (hereafter “SDP”) have been developed. As the name would imply, SDPs are dispersible in the vehicle without dispersants. The black pigment may be stabilized to dispersion by surface treatment to be self-dispersing (see, for example, previously incorporated WO01/94476), by treatment with dispersant in the traditional way, or by some combination of surface treatment and dispersant.

Preferably, when a dispersant is employed, the dispersant(s) is a random or structured polymeric dispersant. Preferred random polymers include acrylic polymer and styrene-acrylic polymers. Most preferred are structured dispersants, which include AB, BAB and ABC block copolymers, branched polymers and graft polymers. Some useful structured polymers are disclosed in U.S. Pat. No. 5,085,698, EP-A-0556649 and U.S. Pat. No. 5,231,131, the disclosures of which are incorporated by reference herein for all purposes as if fully set forth.

Useful pigment particle size is typically in the range of from about 0.005 micron to about 15 micron. Preferably, the pigment particle size should range from about 0.005 to about 5 micron, more preferably from about 0.005 to about 1 micron, and most preferably from about 0.005 to about 0.3 micron.

The black colorant may also be dye as, for example, the black dye disclosed in U.S. Pat. No. 5,753,016. The black colorant may also be a combination of dye and pigment as, for example, disclosed in U.S. Pat. No. 6,277,184. The disclosures of both of the preceding references are incorporated by reference herein for all purposes as if fully set forth

The vehicle can be aqueous or non-aqueous. The term “aqueous vehicle” refers to water or a mixture of water and at least one water-soluble organic solvent (co-solvent). Selection of a suitable mixture depends on requirements of the specific application, such as desired surface tension and viscosity, the selected colorant, drying time of the ink, and the type of substrate onto which the ink will be printed. Representative examples of water-soluble organic solvents that may be selected are disclosed in U.S. Pat. No. 5,085,698 (the disclosure of which is incorporated by reference herein for all purposes as if fully set forth).

If a mixture of water and a water-soluble solvent is used, the aqueous vehicle typically will contain about 30% to about 95% water with the balance (i.e., about 70% to about 5%) being the water-soluble solvent. Preferred compositions contain about 60% to about 95% water, based on the total weight of the aqueous vehicle.

The amount of aqueous vehicle in the ink is typically in the range of about 70% to about 99.8%, and preferably about 80% to about 99.8%, based on total weight of the ink.

The aqueous vehicle can be made to be fast penetrating (rapid drying) by including surfactants or penetrating agents such as glycol ethers and 1,2-alkanediols. Glycol ethers include ethylene glycol monobutyl ether, diethylene glycol mono-n-propyl ether, ethylene glycol mono-iso-propyl ether, diethylene glycol mono-iso-propyl ether, ethylene glycol mono-n-butyl ether, ethylene glycol mono-t-butyl ether, diethylene glycol mono-n-butyl ether, triethylene glycol mono-n-butyl ether, diethylene glycol mono-t-butyl ether, 1-methyl-1-methoxybutanol, propylene glycol mono-t-butyl ether, propylene glycol mono-n-propyl ether, propylene glycol mono-iso-propyl ether, propylene glycol mono-n-butyl ether, dipropylene glycol mono-n-butyl ether, dipropylene glycol mono-n-propyl ether, and dipropylene glycol mono-isopropyl ether. 1,2-Alkanediols are preferably 1,2-C4-6 alkanediols, most preferably 1,2-hexanediol. Suitable surfactants include ethoxylated acetylene diols (e.g. Surfynols® series from Air Products), ethoxylated primary (e.g. Neodol® series from Shell) and secondary (e.g. Tergitol® series from Union Carbide) alcohols, sulfosuccinates (e.g. Aerosol® series from Cytec), organosilicones (e.g. Silwet® series from Witco) and fluoro surfactants (e.g. Zonyl® series from DuPont).

The amount of glycol ether(s) and 1,2-alkanediol(s) added must be properly determined, but is typically in the range of from about 1 to about 15% by weight and more typically about 2 to about 10% by weight, based on the total weight of the ink. Surfactants may be used, typically in the amount of about 0.01 to about 5% and preferably about 0.2 to about 2%, based on the total weight of the ink.

“Non-aqueous vehicle” refers a vehicle that is substantially comprised of a non-aqueous solvent or mixtures of such solvents, which solvents can be polar and/or nonpolar. Examples of polar solvents include alcohols, esters, ketones and ethers, particularly mono- and di-alkyl ethers of glycols and polyglycols such as monomethyl ethers of mono-, di- and tri-propylene glycols and the mono-n-butyl ethers of ethylene, diethylene and triethylene glycols. Examples of nonpolar solvents include aliphatic and aromatic hydrocarbons having at least six carton atoms and mixtures thereof including refinery distillation products and by-products.

Even when no water is deliberately added to the non-aqueous vehicle, some adventitious water may be carried into the formulation, but generally this will be no more than about 2-4%. By definition, the non-aqueous ink of this invention will have no more than about 10%, and preferably no more than about 5%, by weight of water based on the total weight of the non-aqueous vehicle.

Other ingredients may be formulated into the inkjet ink, to the extent that such other ingredients do not interfere with the stability and jetability of the ink, which may be readily determined by routine experimentation. Such other ingredients are in a general sense well known in the art.

Polymers (other than the dispersants) may be added to the ink to improve durability. The polymers can be soluble in the vehicle or dispersed (e.g. “emulsion polymer” or “latex”), and can be ionic or nonionic. Useful classes of polymers include acrylics, styrene-acrylics and polyurethanes.

Biocides may be used to inhibit growth of microorganisms.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclohexanediaminetetraacetic acid (CyDTA), dethylenetriamine-N,N,N′,N″, N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Drop velocity, separation length of the droplets, drop size and stream stability are greatly affected by the surface tension and the viscosity of the ink. Ink jet inks typically have a surface tension in the range of about 20 dyne/cm to about 70 dyne/cm at 25° C. Viscosity can be as high as about 30 cP at 25° C., but is typically somewhat lower. The ink has physical properties that can be adjusted to the ejecting conditions and printhead design. The inks should have excellent storage stability for long periods so as not clog to a significant extent in an ink jet apparatus. Further, the ink should not corrode parts of the ink jet printing device it comes in contact with, and it should be essentially odorless and non-toxic.

Although not restricted to any particular viscosity range or printhead, the application contemplated by this invention will generally require lower viscosity ink. Thus the viscosity (at 25° C.) of the inventive inks can be less than about 7 cps, is preferably less than about 5 cps, and most advantageously is less than about 3.5 cps.

### EXAMPLES

The following abbreviations are used:

BzMA=benzyl methacrylate,

HEMA=hydroxyethylmethacrylate,

ETEGMA=ethyltriethyleneglycolmethatcrylate, and

MM=methacrylic acid.

### Cyan Dispersion

A representative cyan dispersion can be prepared as follows. A mixture of water (159.5 grams), 45.5% KOH (7.3 grams), a polymer dispersant solution (43% solids in 2-pyrrolidone of 13//13/7.5 BzMA//MMA/ETEGMA) (58.1 grams) and P.B. 15:4 pigment (Aztech Chemisperse® Cyan 1541, Magruder Color Company) (75.0 grams), is agitated in a high speed disperser. After the pigment has been fully wetted, an additional 75.0 grams of water is added. The resulting slurry is milled for 4 hours in a 250 ml horizontal media mill. Once the desired particle size is achieved, the dispersion is diluted further with 123.9 grams water and 1.2 grams Proxel GXL (biocide, Avecia). The final concentrate contains 15% percent cyan pigment by weight.

Numerous other examples of PB 15:3 and PB 15:4 dispersions are present in the literature, including the art herein before incorporated by reference.

### Magenta Dispersion

A representative magenta dispersion can be prepared as follows. A mixture of water (127.4 grams), 45.5% KOH (7.3 grams), polymer dispersant solution (43% solids in 2-pyrrolidone of 13//13/7.5 BzMA//MMA/ETEGMA) (58.1 grams) and PR122 pigment (Sunfast Magenta 122 228-2410, Sun Chemical) (75.0 grams), is agitated in a high-speed disperser. After the pigment has been fully wetted, an additional 75.0 grams of water is added. The resulting slurry is milled for 4 hours in a 250 ml horizontal media mill. Once the desired particle size is achieved, the dispersion is diluted further with 123.9 grams water and 1.2 grams Proxel GXL (biocide, Avecia). The final concentrate contains 15% percent magenta pigment by weight.

Numerous other examples of PR 122 dispersions are present in the literature, including the art herein before incorporated by reference.

### Yellow Dispersion

Using the following recipes, dispersions of Y95, Y 128 and Y155 were made by a two-roll mill process as described in U.S. Pat. No. 5,310,778 (the disclosure of which is incorporated by reference herein for all purposes as if fully set forth). The block copolymer dispersants were made according to the procedures described in U.S. Pat. No. 5,221,334 (the disclosure of which is also incorporated by reference herein for all purposes as if fully set forth).

A dispersion of Y95 was prepared from 53 parts by weight Cromophal®) Yellow GR (Ciba) pigment, 36 parts polymer dispersant (BZMA//MAA/ETEGMA, 13//13/7.5) and 11 parts tetraethylene glycol. The dispersion was neutralized with KOH and let down into water to form a 15% pigment concentrate.

A dispersion of Y128 (comparative yellow dispersion) was prepared from 53 parts by weight Cromophthal® Yellow 8GN (Ciba), 31 parts polymer dispersant (BzMA//MAA, 13//10) and 16 parts 2-pyrrolidone. The dispersion was neutralized with KOH and let down into water to form a 15% concentrate.

A dispersion of Y155 (comparative yellow dispersion) was prepared from 57 parts by weight Ink Jet Yellow 4G (Clariant), 29 parts polymer dispersant (BzMA//MM, 13//10) and 14 parts 2-pyrrolidone. The dispersion was neutralized with KOH and let down into water to form a 15% concentrate.

A dispersion of PY 110 (comparative yellow dispersion) was prepared as follows. A mixture of water (89.7 grams), dimethylethanol amine (8.4 grams), polymer dispersant solution (39% solids in 2-pyrrolidone of 13//10 BzMA//MMA) (76.9 grams) and PY 110 pigment (Chromophtal® Yellow 3RT, Ciba Specialty Chemicals) (75.0 grams), was agitated in a high-speed disperser. After the pigment had been fully wetted, 76.1 grams of DI water were added. The resulting slurry was milled for 4 hours with a 250 ml horizontal media mill. Once the desired particle size was achieved, the dispersion was diluted further with 172.7 grams DI water and 1.2 grams Proxel GXL (biocide, Avecia). Final concentrate was 15 weight % yellow pigment.

A dispersion of PY 74 (comparative yellow dispersion) was prepared as follows. A mixture of water (118.5 grams), dimethylethanol amine (7.9 grams), polymer dispersant solution (39% solids in 2-pyrrolidone of 13//10 BzMA//MMA) (73.1 grams) and PY 74 pigment (Aztech Chemisperse® Yellow 7490, Magruder Color Company) (85.5 grams), was agitated in a high-speed disperser. After the pigment had been fully wetted, 217.9 grams of additional water was added. The resulting slurry was milled for 4 hours with a media mill. Once the desired particle size was achieved, the dispersion was diluted further with water and 1.43 grams Proxel GXL (biocide, Avecia), such that the final concentrate was 15 weight % yellow pigment.

### Preparation of the Inks

To prepare the yellow inks, the pigment concentrate was dispersed in the vehicle according to the following recipe such that the final weight of yellow pigment in each case was 3.5% of the total weight of ink.

| Vehicle | Weight Percent |
|---|---|
| Isopropyl alcohol | 2.0 |
| Liponic EG-1 (Lipo Chemicals) | 5.0 |
| 2-pyrrolidone | 9.0 |
| Neopentyl alcohol | 2.0 |
| Proxel GXL (biocide) | 0.2 |
| Water | balance |

### Comparison of the Present Yellow Ink to Other Prior Art Yellow Inks

The primary difference between the present ink set and most prior art ink sets is the choice of yellow colorant. The following table compares yellow pigments Y128, Y110, Y74 and Y155 to the yellow pigment of the inventive set, Y95.

Test patches at 100% coverage were made with each yellow ink by printing with a Hewlett Packard 980 inkjet printer using a 51645 pen. Chroma and hue angle were measured with a Spectroeye (Gretag Macbeth, New Windsor, N.Y.). Light fastness was run according to ASTM G26—Method 3 (continuous exposure to light, no water spray) with Delta E reported after 600 hours of exposure.

| | Chroma | Hue Angle | Delta E (600 hrs) |
|---|---|---|---|
| Y128 | 80 | 98 | 3 |
| Y110 | 104 | 80 | 3 |
| Y74 | 107 | 99 | 60 |
| Y155 | 96 | 95 | 6 |
| Y95 | 108 | 88 | 22 |

Kodak Photo paper 800-6298 (except Y74, Hewlett Packard glossy)

Ideally, the yellow ink will have high chroma to give vibrant prints, a hue angle of 90 degrees to give good balance of color when mated with the other cyan and magenta process colors in the set, and high resistance to light fade. The 90 degree hue angle is considered a ‘pure’ or ‘neutral’ shade of yellow. Pigments with hue angles much greater than 90 appear slightly green; pigments less than 90 appear orange. The data shows that, in comparison to other yellows, Y95 has the highest chroma and the most favorable hue angle. It is somewhat less lightfast than Y128, Y155 and Y110, but still acceptable and clearly much better than Y74.

### Ink Set

An ink set of the present invention can be comprised of, for example, a cyan ink containing the cyan dispersion (about 2-3%) in the vehicle herein before described; a magenta ink containing the magenta dispersion (about 3-4%) in the vehicle herein before described; and, a yellow ink containing the PY95 dispersion (about 3-4%) and vehicle herein before described, wherein percentages indicated are weight percent pigment in the final ink.

Other vehicles can suitably be used, for example, the vehicles described in the art previously incorporated herein by reference. As is well known, each vehicle will be optimized for a particular printer.

1. An ink jet ink set for color printing comprising at least three differently colored inks, wherein:
(i) at least one of the inks is a cyan ink comprising a vehicle and copper phthalocyanine pigment selected from the group consisting of PB 15:3 and PB 15:4;
(ii) at least one of the inks is a magenta ink comprising a vehicle and PR 122 magenta pigment; and
(iii) at least one of the inks is a yellow ink comprising a vehicle and PY 95 yellow pigment.

2. The ink set of claim 1, comprising at least four differently colored inks, wherein at least one of the inks is a black ink

3. The ink set of claim 2, wherein the black ink comprises a vehicle and a carbon black pigment.

4. The ink set of claim 3, wherein the carbon black pigment is a self-dispersing carbon black pigment.

5. The ink set of claim 1, further comprising an orange ink comprising a vehicle and an orange pigment, and/or a green ink comprising a vehicle and a green pigment.

6. The ink jet ink set of claim 5, wherein the orange pigment is selected from the group consisting of C.I. pigment orange 43, 36, 34, 61, 64 and 71; and the green pigment is selected from the group consisting of C.I. pigment green 36 and 7.

7. The ink set of claim 1, wherein each vehicle is an aqueous vehicle.

8. The ink set of claim 3, wherein each vehicle is an aqueous vehicle.

9. The ink set of claim 5, wherein each vehicle is an aqueous vehicle.

10. A method for ink jet printing onto a substrate, comprising the steps of:
A) providing an ink jet printer that is responsive to digital data signals;
B) loading the printer with a substrate to be printed;
C) loading the printer with the ink jet ink set; and
D) printing onto the substrate using the inkjet ink set in response to the digital data signals,
wherein the inkjet ink set comprises at least three differently colored inks, wherein:
(i) at least one of the inks is a cyan ink comprising a vehicle and copper phthalocyanine pigment selected from the group consisting of PB 15:3 and PB 15:4;
(ii) at least one of the inks is a magenta ink comprising a vehicle and PR 122 magenta pigment; and
(iii) at least one of the inks is a yellow ink comprising a vehicle and PY 95 yellow pigment.

11. The method of claim 10, wherein the ink set comprises at least four differently colored inks, wherein at least one of the inks is a black ink

12. The method of claim 11, wherein the black ink comprises a vehicle and a carbon black pigment.

13. The method of claim 12, wherein the carbon black pigment is a self-dispersing carbon black pigment.

14. The method of claim 10, wherein the ink set comprises further comprises an orange ink comprising a vehicle and an orange pigment, and/or a green ink comprising a vehicle and a green pigment.

15. The method of claim 14, wherein the orange pigment is selected from the group consisting of C.I. pigment orange 43, 36, 34, 61, 64 and 71; and the green pigment is selected from the group consisting of C.I. pigment green 36 and 7.

16. The method of claim 10, wherein each vehicle is an aqueous vehicle.

17. The method of claim 12, wherein each vehicle is an aqueous vehicle.

18. The method of claim 14, wherein each vehicle is an aqueous vehicle.
